(19) United States
(12) Patent Application Publication
(10) Pub. No.: US 2025/0012693 A1
(43) Pub. Date: Jan. 9, 2025

(54) CONNECTION UNIT, VIBRATION-TUBE MODULE, AND MODULAR MEASURING DEVICE FOR DETERMINING THE DENSITY OF A MEASUREMENT MEDIUM

(71) Applicant: Endress+Hauser Flowtec AG, Reinach (CH)

(72) Inventors: Benjamin Schwenter, Ettingen (CH); Marc Werner, Grenzach-Wyhlen (DE); Markus Schütz, Lampenberg (CH)

(21) Appl. No.: 18/579,435

(22) PCT Filed: Jul. 4, 2022
(86) PCT No.: PCT/EP2022/068404

§ 371 Date: Jan. 15, 2024

(30) Foreign Application Priority Data
Jul. 14, 2021 (DE) 10 2021 118 263.8

(51) Int. Cl. G01N 9/32

(52) U.S. Cl. CPC G01N 9/32

(57) ABSTRACT

A connection unit for at least one vibration-tube module of a modular measuring device for determining the density of a measurement medium includes: a measurement-medium inlet, which extends along a first axis; a measurement-medium outlet, which extends along a second axis; at least a first vibration-tube inlet, which is fluidically connected to the measurement-medium inlet; and at least a first vibration-tube outlet, which is fluidically connected to the measurement-medium outlet, wherein the measurement-medium inlet and the measurement-medium outlet are opposite each other such that they are separated with respect to a first plane and are mechanically connected to each other by at least one support unit, and wherein the first axis and the second axis each form an angle of greater than 45° to the first plane.

The invention relates to a connection unit, a vibration-tube module, and a modular measuring device for determining the density of a measurement medium.

Such measuring apparatuses are also called Coriolis measuring apparatuses. To measure the density of a measurement medium, it is passed through a vibration tube of the measuring apparatus, while the vibration tube is vibrated by an exciter and the resulting vibration of the vibration tube is measured. The resulting vibration depends on the density of the measurement medium flowing through the vibration tube. By comparing the exciter vibration and the resulting vibration, the density of the measurement medium can finally be deduced. Such comparison uses, for example, a phase shift or a change in amplitude between the exciter vibration and the resulting vibration of the vibration tube.

In some industrial applications, measurement media that entail time-consuming and cost-intensive cleaning of the vibration tube are used. For such applications, it is desirable to replace all parts of the Coriolis measuring apparatus that come into contact with the measurement medium after each measuring cycle, i.e., to use them only once. Such a Coriolis measuring apparatus is known, for example, from the as yet unpublished patent application DE 102021105397.8.

The parts of the Coriolis measuring apparatus to be replaced are in particular the vibration tube and the connection unit of the Coriolis measuring apparatus. The Coriolis measuring apparatus and the parts to be replaced must meet criteria such as low manufacturing costs, maximum reliability and maximum quality. These criteria cannot be achieved in an obvious manner in particular for the connection unit, because the connection unit has a complex geometric shape and is exposed to high loads during operation.

It is therefore an object of the invention to provide a connection unit that causes low manufacturing costs but allows maximum reliability and maximum quality during operation.

This object is achieved according to the invention by a connection unit for at least one vibration-tube module of a modular measuring device for determining the density of a measurement medium according to claim 1.

The connection unit according to the invention comprises:
a measurement-medium inlet, which extends along a first axis,
a measurement-medium outlet, which extends along a second axis,
at least a first vibration-tube inlet, which is fluidically connected to the measurement-medium inlet,
at least a first vibration-tube outlet, which is fluidically connected to the measurement-medium outlet,
   wherein the measurement-medium inlet and the measurement-medium outlet are opposite from each other, such that they are separated from each other with respect to a first plane, and are mechanically connected to each other by means of at least one support unit, and wherein the first axis and the second axis each form an angle of greater than 45° to the first plane.

By using the connection unit according to the invention, in particular, thanks to the support unit, which mechanically connects the measurement-medium inlet to the measurement-medium outlet, it is possible for loads occurring during operation to be absorbed by the measurement-medium inlet and the measurement-medium outlet. This prevents individual regions of the connection unit from being subjected to an excessive load. The resulting force distribution allows the connection unit to be produced using materials and wall thicknesses or geometries that contribute to reducing the production costs.

According to one embodiment of the invention, the connection unit further comprises a mounting region for detachably fastening the connection unit in a modular measuring device.

According to one embodiment of the invention, the connection unit is made of a material comprising a plastic.

According to one embodiment of the invention, the first vibration-tube inlet extends along a third axis and the first vibration-tube outlet extends along a fourth axis. The third axis and the fourth axis lie in a second plane, which is arranged orthogonally to the first plane.

According to one embodiment of the invention, the connection unit further comprises a second vibration-tube inlet, which is fluidically connected to the measurement-medium inlet, and further comprises a second vibration-tube outlet, which is fluidically connected to the measurement-medium outlet, so that the connection unit can be used for a second vibration tube of a modular measuring device.

The aforementioned object is further achieved by a connection unit for at least one vibration-tube module of a modular measuring device for determining the density of a measurement medium according to claim 6.

The connection unit according to the invention comprises:
a measurement-medium inlet, which extends along a first axis,
a measurement-medium outlet, which extends along a second axis,
a tubular support unit, which has a tube inlet and a tube outlet,
a first vibration-tube inlet, which is fluidically connected to the measurement-medium inlet,
a first vibration-tube outlet, which is connected to the tube inlet of the tubular support unit,
a second vibration-tube inlet, which is connected to the tube outlet of the tubular support unit,
a second vibration-tube outlet, which is fluidically connected to the measurement-medium outlet,
   wherein the measurement-medium inlet and the measurement-medium outlet are opposite from each other, such that they are separated from each other with respect to a first plane, and are mechanically connected to each other by means of the tubular support unit, and wherein the first axis and the second axis each form an angle of greater than 45° to the first plane.

The aforementioned object is further achieved by a vibration-tube module for a modular measuring device according to claim 7.

The modular measuring device according to the invention comprises:
a connection unit according to the invention,
a first vibration tube, which has a fixing region, a first tube entrance and a first tube exit, wherein the fixing region is complementary to the fastening region of the connection unit, and the fixing region is connected to the fastening region in a force-closed manner by means of gluing, screwing, welding or riveting, and
   wherein the first tube entrance is connected to the first vibration-tube inlet of the connection unit, and the first tube exit is connected to the first vibration-tube outlet of the connection unit.

According to one embodiment of the invention, a pin of the fixing region is welded to a through hole of the fastening region.

The aforementioned object is further achieved by a modular measuring device for determining the density of a measurement medium according to claim 9.

The modular measuring device according to the invention comprises:
a vibration-tube module according to the invention,
a holding device that is suitable for being connected to the mounting region of the connection unit in order to detachably fasten the vibration-tube module in the holding device.

According to one embodiment of the invention, the modular measuring device further comprises a locking element for releasably locking the vibration-tube module in the measuring device in the mounting region.

According to one embodiment of the invention, the locking element is a clamping lock.

The invention is explained in more detail on the basis of the following description of the figures. In the figures:

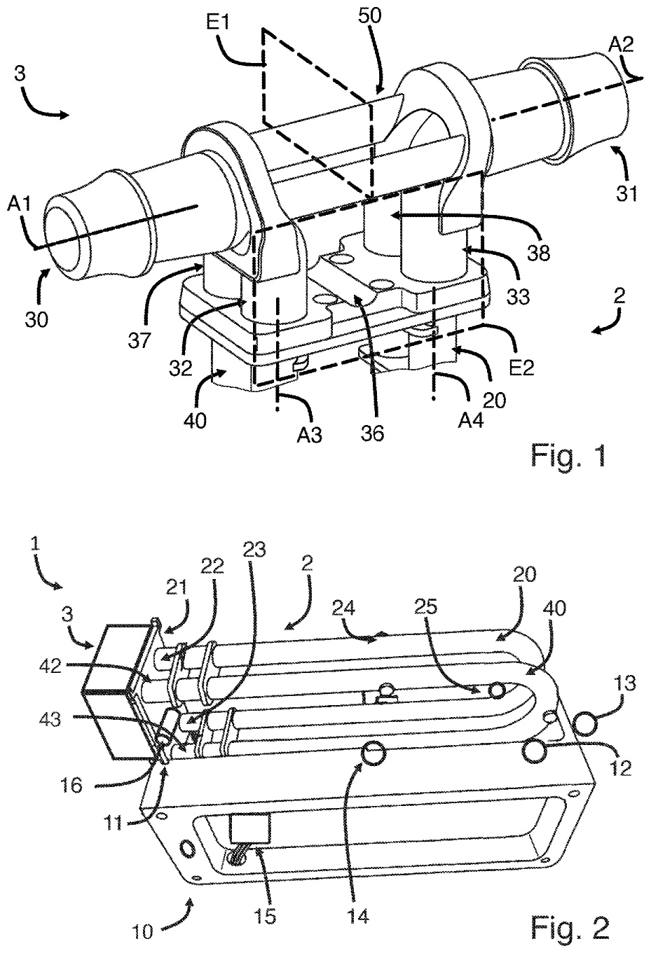

FIG. 1: shows a representation of a connection unit according to the invention;

FIG. 2: shows a measuring device having a vibration-tube module having the connection unit of FIG. 1;

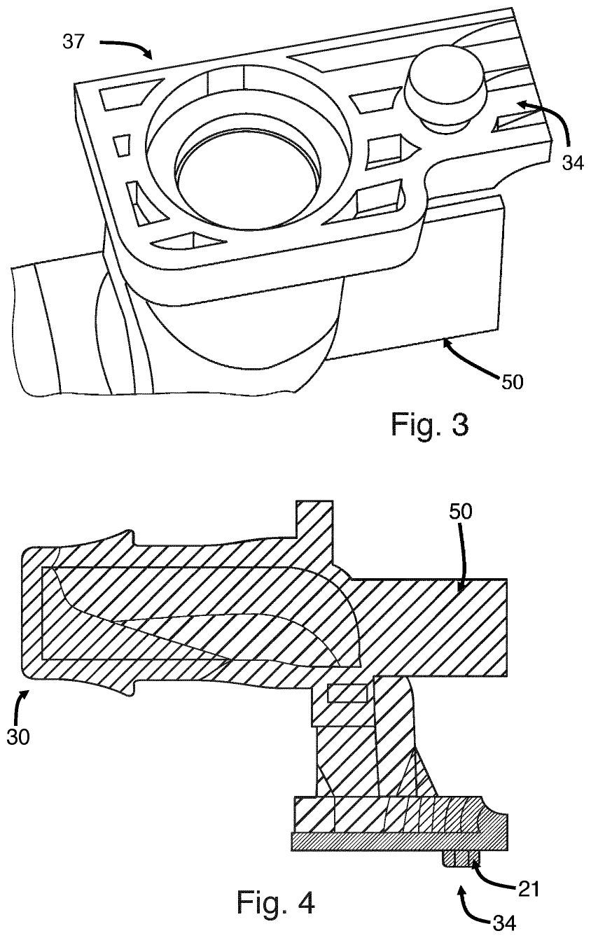

FIG. 3: shows an exemplary embodiment of the connection unit shown in FIG. 1, with a fastening region;

FIG. 4: shows a sectional representation of the connection unit shown in FIG. 1;

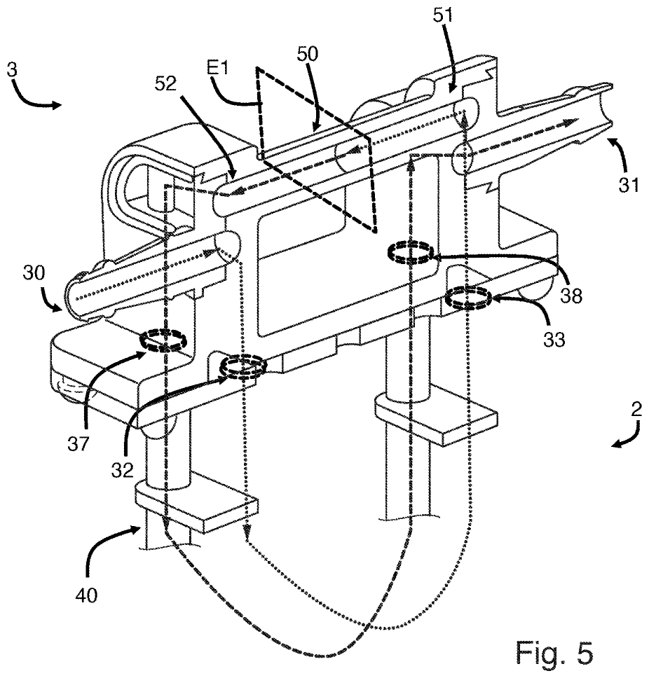

FIG. 5: shows an alternative embodiment of a connection unit according to the invention.

FIG. 1 shows an exemplary representation of a connection unit 3 according to the invention for a vibration-tube module 2 of a modular measuring device 1.

The modular measuring device 1 can be seen as a whole in FIG. 2. However, the connection unit 3 is only indicated schematically there. The connection unit 3 adjoins at least a first vibration tube 20 in order to form the vibration-tube module 2.

The connection unit 3 comprises a measurement-medium inlet 30, a measurement-medium outlet 31, at least a first vibration-tube inlet 32, and at least a first vibration-tube outlet 33. The connection unit 3 is preferably made of a cost-effective material, for example plastic, in particular PP, PC, nylon, PSU or PVDF. The connection unit 3 is preferably selected from a plastic that can be sterilized by gamma radiation. The material for the connection unit 3 is preferably transparent, so that the user can see when the measurement medium flows through the connection unit 3. The connection unit 3 is produced, for example, by means of an injection-molding method.

The measurement-medium inlet 30 is used to admit a measurement medium into the connection unit 3 or into the vibration-tube module 2. For this purpose, the measurement-medium inlet 30 has, for example, a geometry that makes it possible to push a hose over the measurement-medium inlet 30 and, if necessary, to fix said hose on the measurement-medium inlet 30 by means of a fastening means, for example a cable tie or a clamp. For this purpose, the measurement-medium inlet 30 is mushroom-shaped, for example. The measurement-medium inlet 30 extends along a first axis A1 and is fluidically connected to at least the first vibration-tube inlet 32. As shown by way of example in FIG. 1, the measurement-medium inlet 30 can also be fluidically connected to a second vibration-tube inlet 37. The measurement-medium inlet 30 thus serves as a distributor for the measurement medium. The measurement medium can thus flow simultaneously through two vibration tubes.

The measurement-medium outlet 31 is used to discharge a measurement medium from the connection unit 3 or the vibration-tube module 2. The measurement-medium outlet 31 is preferably identical to the measurement-medium inlet 30. The measurement-medium outlet 31 extends along a second axis A2 and is fluidically connected to at least a first vibration-tube outlet 33. The measurement-medium outlet 31 can additionally be connected to a second vibration-tube outlet 38, as shown in FIG. 1.

The measurement-medium inlet 30 and the measurement-medium outlet 31 are opposite from each other. The measurement-medium inlet 30 and the measurement-medium outlet 31 are separated from each other with respect to a first plane E1, i.e., the first plane E1 extends between the measurement-medium inlet 30 and the measurement-medium outlet 31. The first plane E1 forms, for example, a mirror plane for the measurement-medium inlet 30 and the measurement-medium outlet 31 and/or the connection unit 3.

A support unit 50 mechanically connects the measurement-medium inlet 30 to the measurement-medium outlet 31, thus allowing forces acting on the measurement-medium inlet 30 to be efficiently transmitted to the measurement-medium outlet 31, and vice versa. The support unit 50 has, for example, two struts (see FIG. 1). Of course, the support unit 50 can also have fewer or more than two struts. The cross-sectional area of the strut(s) can be selected as desired. The cross-sectional area of the strut(s) is, for example, rectangular, square, circular, elliptical, annular, or the like. The struts are preferably arranged parallel to the first axis A1 and to the second axis A2, so that the forces acting on the measurement-medium inlet 30 and/or on the measurement-medium outlet 31 can be optimally transmitted between the measurement-medium inlet 30 and the measurement-medium outlet 31. The strut(s) is/are preferably designed such that the axial area moment of inertia of the strut(s) is greatest. The cross-sectional form of the strut(s) thus preferably has a height that exceeds its width, the height being measured parallel to the third axis A3 (see FIG. 1).

The first axis A1 and the second axis A2 are arranged at an angle of greater than 45° to the first plane E1. This allows for optimal force transmission between the measurement-medium inlet 30 and the measurement-medium outlet 31 by means of the support unit 50. Preferably, the first axis A1 and the second axis A2 are arranged at an angle between, or equal to, 45° and 90° to the first plane E1. It is thus achieved that forces acting on the measurement-medium inlet 30 and/or the measurement-medium outlet 31 are optimally transmitted by the support unit 50, and hoses connected to the connection unit 3 can be led away from the modular measuring device 1 in a space-saving manner. Most preferably, the first axis A1 and the second axis A2 are arranged at an angle of 90° to the first plane E1.

The connection unit 3 also has a mounting region 36 for detachably mounting the connection unit 3 in the modular measuring device 1. The mounting region 36 is preferably arranged centrally between the measurement-medium inlet 30 and the measurement-medium outlet 31. The mounting region 36 is suitable for a locking element 16 of the modular measuring device 1 to engage in the mounting region 36 in a detachable manner. The locking element 16 is, for example, a clamping lock. The clamping lock is formed, for example, by means of a rod that is fastened to the holding device 10.

The mounting region 36 is, for example, a channel-like depression for receiving a cylindrical bar, i.e., the locking element 16, as shown schematically in FIG. 2. Of course, the mounting region 36 can also have other geometric shapes, such as a bore with a screw thread or other shapes. The mounting region 36 allows the vibration-tube module 2 to be fixed quickly and securely in a holding device 10 of the modular measuring device 1. Modular use of the modular measuring device 1, i.e., the use of different vibration-tube modules 2, is thus facilitated.

The first vibration-tube inlet 32 is arranged along a third axis A3, and the first vibration-tube outlet 33 is arranged along a fourth axis A4. If present, the second vibration-tube inlet 37 is arranged parallel to the third axis A3. If present, the second vibration-tube outlet 38 is arranged parallel to the fourth axis A4. Preferably, the third axis A3 and the fourth axis A4 are arranged parallel to each other. The third axis A3 and the fourth axis A4 are arranged in a second plane E2. Preferably, the first axis A1 and the second axis A2 are arranged parallel to the second plane E2. The first plane E1 and the second plane E2 are preferably arranged orthogonally to each other.

FIG. 3 shows the connection unit 3 with a view of the second vibration-tube inlet 37. A recess is preferably provided in the second vibration-tube inlet 37 in order to receive an O-ring. The same applies to the first vibration-tube inlet 32, the first vibration-tube outlet 33 and the second vibration-tube outlet 38. The connection unit 3 has a fastening region 34 in order to be connected to a fixing region 21 of the first vibration tube 20 and/or of the second vibration tube 40. The fastening region 34 of the connection unit 3 preferably has a pin that can be connected, at its extremity, to a through hole of the fixing region 21 (see FIG. 3 and FIG. 4). For the force-closed connection of the connection unit 3 to the first vibration tube 20, for example the pin is inserted into the through hole and deformed by ultrasonic welding, so that an interlocking connection is created between the connection unit 3 and the vibration-tube module 2. Of course, other connection techniques are also possible in order to create a force-closed connection between the connection unit 3 and the first vibration tube 20 or the connection unit 3 and the second vibration tube 40.

FIG. 4 shows the pin of the fastening region 34, which is connected to the through hole of the fixing region 21. The pin can of course also be formed by a rivet or screw or the like. According to an alternative embodiment, the pin or rivet or screw can also be dispensed with if the fastening region 34 of the connection unit 3 is permanently connected to the fixing region 21 of the vibration-tube module 2 by a different type of fastening. Such other types of fastening include, for example, gluing, welding, or similar types of fastening. An advantage of permanent fastening types is that a seal between the connection unit 3 and the vibration module 2 can be dispensed with.

FIG. 2 shows the modular measuring device 1, which further preferably has a receptacle 11 in the holding device 10 in order to fasten the vibration-tube module 2 in the modular measuring device 1. The receptacle 11 is, for example, a groove. The modular measuring device 1 has, for example, a temperature sensor 12 and a primary exciter component 13, which is suitable for interacting with a secondary exciter component 25 of the first vibration tube 20 in order to cause the first vibration tube 20 to vibrate. Furthermore, the modular measuring device 1 has a primary sensor component 14 that is suitable for interacting with a secondary sensor component 24 in order to determine the vibration of the first vibration tube 20. The second vibration tube 40 is identical to the first vibration tube 20 and has the same components in order to cause the second vibration tube 40 to vibrate and to determine the vibration of the second vibration tube 40.

The first vibration tube 20 has a first tube entrance 22 and a first tube exit 23. When the first vibration tube 20 is connected to the connection unit 3, thus forming the vibration-tube module 2, the first tube entrance 22 is connected to the first vibration-tube inlet 32 of the connection unit 3, and the first tube exit 23 is connected to the first vibration-tube outlet 33 of the connection unit 3. A sealing ring is preferably arranged between the first vibration-tube inlet 32 and the first tube entrance 22 and between the first vibration-tube outlet 33 and the first tube exit 23 (not shown).

The second vibration tube 40 is identical to the first vibration tube 20 and is arranged such that the second vibration-tube inlet 37 and the second vibration-tube outlet 38 are in fluid communication with the second tube entrance 42 and the second tube exit 43, respectively, of the second vibration tube 40.

FIG. 5 shows a sectional drawing of an alternative embodiment of the connection unit 3, in which the support unit 50 is designed as a tube. This embodiment is compatible with the embodiments described above, to the extent technically possible. In this embodiment, the tube is preferably arranged with its longitudinal axis orthogonal to the first plane E1. The tube has a tube inlet 51 and a tube outlet 52. The tube has, for example, an inner diameter between 2 mm and 15 mm and a wall thickness between 0.5 mm and 4 mm. In this embodiment, the measurement-medium inlet 30 is connected only to the first vibration-tube inlet 32 (because of the sectional drawing this is indicated only schematically with dotted ellipses and dashes). The tube fluidically connects the first vibration-tube outlet 33 to the second vibration-tube inlet 37. The tube inlet 51 is thus connected to the first vibration-tube outlet 33, and the tube outlet 52 is connected to the second vibration-tube inlet 37. In this embodiment, the measurement-medium outlet 31 is connected only to the second vibration-tube outlet 38. As a result of this alternative embodiment, when the connection unit 3 is connected to a vibration-tube module 2 having a first vibration tube 20 and a second vibration tube 40, the measurement medium is guided first through the first vibration tube 20 and then through the second vibration tube 40. In FIG. 5, it was not possible to show the first vibration tube 20 because of the sectional drawing. The dotted lines partially indicate the course of the first vibration tube 20, and the dashed lines partially indicate the course of the second vibration tube 40. Because the measurement medium is guided first through the first vibration tube 20 and subsequently through the second vibration tube 40 in this embodiment, this embodiment is particularly well suited for high-precision measurements. The vibration-tube module 2 described above, or the modular measuring device described above, can of course also be operated with the alternative embodiment of the connection unit 3.

### LIST OF REFERENCE SIGNS

1 Modular measuring device
2 Vibration-tube module
3 Connection unit
10 Holding device
11 Receptacle
12 Temperature sensor
13 Primary exciter component
14 Primary sensor component
15 Control unit
16 Locking element
20 First vibration tube
21 Fixing region
22 First tube entrance
23 First tube exit
24 Secondary sensor component
25 Secondary exciter component
30 Measurement-medium inlet
31 Measurement-medium outlet
32 First vibration-tube inlet
33 First vibration-tube outlet
34 Fastening region
36 Mounting region
37 Second vibration-tube inlet
38 Second vibration-tube outlet
40 Second vibration tube
42 Second tube entrance
43 Second tube exit
50 Support unit
51 Tube inlet
52 Tube outlet
A1 First axis
A2 Second axis
A3 Third axis
A4 Fourth axis
E1 First plane
E2 Second plane

1-11. (canceled)

12. A connection unit for at least one vibration-tube module of a modular measuring device for determining the density of a measurement medium, the connection unit comprising:
a measurement-medium inlet, which extends along a first axis;
a measurement-medium outlet, which extends along a second axis;
a first vibration-tube inlet, which is fluidically connected to the measurement-medium inlet; and
a first vibration-tube outlet, which is fluidically connected to the measurement-medium outlet,
wherein the measurement-medium inlet and the measurement-medium outlet are opposite each other, separated from each other with respect to a first plane, and mechanically connected to each other by at least one support unit, and
wherein the first axis and the second axis each form an angle of greater than 45° to the first plane.

13. The connection unit according to claim 12, further comprising a mounting region configured to detachably fasten the connection unit in a modular measuring device.

14. The connection unit according to claim 12, wherein the connection unit is made of a material comprising a plastic.

15. The connection unit according to claim 12, wherein the first vibration-tube inlet extends along a third axis and the first vibration-tube outlet extends along a fourth axis, the third axis and the fourth axis lying in a second plane, which is arranged orthogonally to the first plane.

16. The connection unit according to claim 12, further comprising a second vibration-tube inlet, which is fluidically connected to the measurement-medium inlet, and a second vibration-tube outlet, which is fluidically connected to the measurement-medium outlet, such that the connection unit is operable for a second vibration tube of the modular measuring device.

17. A connection unit for at least one vibration-tube module of a modular measuring device for determining the density of a measurement medium, the connection unit comprising:
a measurement-medium inlet, which extends along a first axis;
a measurement-medium outlet, which extends along a second axis;
a tubular support unit, which includes a tube inlet and a tube outlet;
a first vibration-tube inlet, which is fluidically connected to the measurement-medium inlet;
a first vibration-tube outlet, which is connected to the tube inlet of the tubular support unit;
a second vibration-tube inlet, which is connected to the tube outlet of the tubular support unit; and
a second vibration-tube outlet, which is fluidically connected to the measurement-medium outlet,
wherein the measurement-medium inlet and the measurement-medium outlet are opposite each other, separated from each other with respect to a first plane, and mechanically connected to each other by the tubular support unit, and
wherein the first axis and the second axis each form an angle of greater than 45° to the first plane.

18. A vibration-tube module for a modular measuring device, the vibration-tube module comprising:
a connection unit according to claim 12,
a first vibration tube including a fixing portion, a first tube entrance, and a first tube exit,
wherein the fixing portion is complementary to a fastening region of the connection unit, and wherein the fixing portion is connected to the fastening region in a force-closed manner by gluing, screwing, welding, or riveting, and
wherein the first tube entrance is connected to the first vibration-tube inlet of the connection unit, and the first tube exit is connected to the first vibration-tube outlet of the connection unit.

19. The vibration-tube module according to claim 18, wherein a pin of the fixing portion is welded to a through hole of the fastening region.

20. A modular measuring device for determining the density of a measurement medium, the modular measuring device comprising:
a vibration-tube module according to claim 18,
a holding device operable to being connected to the mounting region of the connection unit as to detachably fasten the vibration-tube module in the holding device.

21. The modular measuring device according to claim 20, further comprising a locking element for releasably locking the vibration-tube module in the measuring device in the mounting region.

22. The modular measuring device according to claim 21, wherein the locking element is a clamping lock.
